(19) United States
(12) Patent Application Publication
(10) Pub. No.: US 2026/0201234 A1
(43) Pub. Date: Jul. 16, 2026

(54) NANOPARTICLE COOLANT ADDITIVE FOR DIRECT-TO-CHIP COOLING

(71) Applicant: HTMS (DTC IP) LIMITED, DUBLIN 2 (IE)

(72) Inventors: CLAUDIO GRISONI, Roma (IT); GITA SINGH, DUBLIN 1 (IE); PIERO NEGRO, TORCHIAROLO (IT)

(73) Assignee: HTMS (DTC IP) LIMITED, DUBLIN 2 (IE)

(21) Appl. No.: 19/449,883

(22) Filed: Jan. 15, 2026

Related U.S. Application Data
(60) Provisional application No. 63/745,933, filed on Jan. 16, 2025.

(51) Int. Cl. C09K 5/10; C09K 5/20

(52) U.S. Cl. CPC C09K 5/10; C09K 5/20

(57) ABSTRACT

A nanofluid includes a base fluid, a mixed carbon solvent, a mixed metal salt precursor, a peptizing agent, an organic acid, a buffering agent and a surfactant. Systems and methods are disclosed.

### TECHNICAL FIELD

The present disclosure relates, in general, to heat transfer mixtures, and more particularly, to homogenous nanofluids for direct-to-chip cooling that provide long-term stability, low viscosity and zero sedimentation, as well as processes/methods for making such nanofluids.

### BACKGROUND

For well over a century, micro-sized particles with high thermal conductivity have been used to increase the thermal characteristics of working fluids. However, micro-sized particles can be abrasive and can precipitate out due to their higher density. More recently, nano-sized particles were introduced into a base liquid to constitute a nanofluid. In particular, metal additives, such as, for example, copper, aluminum, or carbon have been used as nanoparticles to create colloidal suspension fluids with enhanced thermal characteristics versus mixtures that do not include such nanoparticles. Indeed, conventional nanofluids have shown varying degrees of improvement in thermal performance with the addition of the nanoparticles to the thermal fluid.

However, many conventional nanofluids rely solely on the metal additives to transfer heat, and lack other features to transfer heat, thus limiting the ability of such conventional nanofluids to transfer heat. Furthermore, such conventional nanofluids are often not homogenous, and hence fail to provide long-term stability. Still further such conventional nanofluids are often viscous and/or produce unwanted sedimentation during use.

As such, a need currently exists for a commercially viable nanofluid that is homogenous and provides long-term stability, low viscosity and zero sedimentation. There is also a need for a commercially viable nanofluid that is capable of directly contacting the surface of a computer chip (e.g., CPU or GPU) through a cold plate, to efficiently absorb heat generated by the chip and transfer it away to a heat exchanger, thus allowing for significantly better cooling performance compared to conventional nanofluids that are not used with direct-to-chip cooling. This disclosure describes an improvement over these prior art technologies.

### SUMMARY

In one embodiment, a nanofluid, in accordance with the principles of

the present disclosure, comprises: a base fluid; a mixed carbon solvent; a mixed metal salt precursor; a peptizing agent; an organic acid; a buffering agent; and a surfactant.

In some embodiments, the base fluid is selected from the group consisting of tap water, distilled water, heat transfer fluids, dielectric fluid, NOVEC™, FLUOROINERT™, propylene glycol, ethylene glycol, water-glycol mixtures and combinations thereof.

In some embodiments, the base fluid is distilled water.

In some embodiments, the mixed carbon solvent comprises mixed carbon additives and an inorganic acid.

In some embodiments, the mixed carbon additives are selected from the group consisting of carbon dots, single-walled carbon nanotubes, multi-walled carbon nanotubes and combinations thereof.

In some embodiments, the mixed carbon additives are single-walled carbon nanotubes.

In some embodiments, the inorganic acid is selected from the group consisting of phosphoric acid, sulphuric acid, hydrochloric acid, boric acid and combinations thereof.

In some embodiments, the mixed metal salt precursor comprises a first mixed metal salt precursor and a second mixed metal salt precursor; and the first mixed metal salt precursor is different than the second mixed metal salt precursor.

In some embodiments, the first mixed metal salt precursor is selected from the group consisting of iron (III) chloride hexahydrate (FeCl₃·6H₂O), cupric (II) chloride dihydrate (CuCl₂·2H₂O), silver nitrate (AgNO₃), Cobalt (II) nitrate hexahydrate (Co(NO₃)₂·6H₂O), Nickel (II) chloride hexahydrate (NiCl₂·6H₂O), Manganese (II) chloride, Zinc sulfate heptahydrate (ZnSO₄·7H₂O) and combinations thereof; and the second mixed metal salt precursor is selected from the group consisting of FeCl₃·6H₂O, CuCl₂·2H₂O, AgNO₃, Co(NO₃)₂·6H₂O, NiCl₂·6H₂O, Manganese (II) chloride, ZnSO₄·7H₂O and combinations thereof.

In some embodiments, the peptizing agent is selected from the group consisting of Cetyltrimethylammonium bromide (CTAB), Ammonium hydroxide (NH₄OH), Tetra-n-butylammonium bromide (TBAB), 2-imidazole, Sodium citrate (Na₃C₆H₅O₇), Polyvinylpyrrolidone (PVP), Potassium oleate, Triethanolamine (TEA) and combinations thereof.

In some embodiments, the organic acid is selected from the group consisting of Acetic acid (CH₃COOH), Oxalic acid (C₂H₂O₄), Citric acid (C₆H₈O₇), Lactic acid (C₃H₆O₃), Salicylic acid (C₇H₆O₃), tannic acid, Gallic Acid (C₇H₆O₅) and combinations thereof.

In some embodiments, the surfactant comprises mixed organic surfactants.

In some embodiments, the surfactant comprises a first surfactant and a second surfactant; and the first surfactant is different than the second surfactant.

In some embodiments, the first surfactant is selected from the group consisting of Sodium Dodecyl Benzene Sulfonate (SDBS), Cetyltrimethylammonium Bromide (CTAB), Benzalkonium Chloride, Triton X-100, PVP K-15, PVP K-17, PVP K-25, PVP K-30, PVP 58000, PVP K-90, Carboxymethyl Cellulose (CMC) and combinations thereof; and the second surfactant is selected from the group consisting of SDBS, CTAB, Benzalkonium Chloride, Triton X-100, PVP K-15, PVP K-17, PVP K-25, PVP K-30, PVP 58000, PVP K-90, CMC and combinations thereof.

In some embodiments, the buffering agent comprises NaOH.

In some embodiments, the nanofluid has a pH between about 8.0 and about 14.0.

In some embodiments, the nanofluid has a pH of about 8.0.

In some embodiments, the nanofluid comprises: about 0.01 mL to about 6.0 mL of the peptizing agent and the organic acid; and about 0.001 g to about 5.0 g of the surfactant.

In some embodiments, the nanofluid comprises: about 0.05 mL to about 3.0 mL of the peptizing agent and the organic acid; and about 0.005 g to about 2.5 g of the surfactant.

In some embodiments, the mixed carbon solvent comprises between about 0.01 g and about 4.0 g of mixed carbon additives that are treated with inorganic acids; the mixed metal salt precursor comprises between about 1.0 mmol and about 8.0 mmol of a first mixed metal salt precursor and between about 1.0 mmol and about 4.0 mmol of a second mixed metal salt precursor; the surfactant comprises between about 5 wt % and about 15 wt % of a first surfactant and between about 5.0 wt % and about 10 wt % of a second surfactant; and the nanoparticle coolant additive comprises: between about 0.1 mL and about 5.0 mL of the peptizing agent, between about 5 mmol and about 20 mmol of the organic acid, and between about 0.01 M and about 0.2 M of the buffering agent.

In some embodiments, the mixed carbon solvent comprises about 0.1 g to about 2.0 g of mixed carbon additives that are treated with inorganic acids; the mixed metal salt precursor comprises about 4.2 mmol of a first mixed metal salt precursor and about 2 mmol of a second mixed metal salt precursor; the surfactant comprises about 15 wt % of a first surfactant and about 10 wt % of a second surfactant; and the nanoparticle coolant additive comprises: about 0.5 mL to about 2.5 mL of the peptizing agent, about 10 mmol of the organic acid, and about 0.1 M of the buffering agent.

In some embodiments, the base fluid comprises distilled water; the mixed carbon solvent comprises between about 0.1 g and about 0.5 g of single-walled carbon nanotubes that are treated with between about 5 mL and about 20 mL of sulfuric acid; the surfactant comprises between about 0.01 and about 0.15 g of polyvinylpyrrolidone (PVP), between about 0.01 g and about 0.1 g of sodium dodecylbenzenesulfonate (SDBS) and between about 0.25 g and about 1.0 g of cupric (II) chloride dihydrate (CuCl₂·2H₂O); the peptizing agent comprises between about 1.0 g and about 4.0 g of 2-imidzole; the organic acid comprises between about 0.3 g and about 1.2 g of oxalic acid; the buffering agent comprises NaOH; and the nanoparticle coolant additive has a pH of about 8.

In some embodiments, the base fluid comprises distilled water; the mixed carbon solvent comprises about 0.2 g of single-walled carbon nanotubes that are treated with 10 mL of sulfuric acid; the surfactant comprises about 0.15 g of polyvinylpyrrolidone (PVP), about 0.1 g of sodium dodecylbenzenesulfonate (SDBS) and about 0.5 g of cupric (II) chloride dihydrate (CuCl₂·2H₂O); the peptizing agent comprises about 2.0 g of 2-imidzole; the organic acid comprises about 0.6 g of oxalic acid; the buffering agent comprises NaOH; and the nanoparticle coolant additive has a pH of about 8.

In some embodiments, the mixed carbon solvent comprises between about 0.1 g and about 0.4 g of single-walled carbon nanotubes that are treated with between about 5 mL and about 30 mL of sulfuric acid and between about 1.0 mL and about 10.0 mL of nitric acid; the surfactant comprises between about 0.1 g and about 0.8 g of polyvinylpyrrolidone (PVP); and the nanoparticle coolant additive has a pH of about 8.

In some embodiments, the mixed carbon solvent comprises about 0.4 g of single-walled carbon nanotubes that are treated with about 15 mL of sulfuric acid and about 5 mL of nitric acid; the surfactant comprises about 0.4 g of polyvinylpyrrolidone (PVP); and the nanoparticle coolant additive has a pH of about 8.

In some embodiments, the mixed carbon solvent comprises between about 0.1 g and about 0.6 g of single-walled carbon nanotubes that are treated with between about 5 mL and about 20 mL of nitric acid; the surfactant comprises between about 0.1 g and about 0.5 g of cupric (II) chloride dihydrate (CuCl₂·2H₂O), between about 0.01 and about 0.4 g of zinc nitrate hexahydrate, between about 5 mmol and about 20 mmol of succinic acid, between about 3 mL and about 12 mL of a tetra methyl ammonium chloride solution and between about 0.1 g and about 1.0 g of polyvinylpyrrolidone (PVP); and the nanoparticle coolant additive has a pH of about 8.

In some embodiments, the mixed carbon solvent comprises about 0.3 g of single-walled carbon nanotubes that are treated with about 10 mL of nitric acid; the surfactant comprises about 0.23 g of cupric (II) chloride dihydrate (CuCl₂·2H₂O), about 0.16 g of zinc nitrate hexahydrate, about 10 mmol of succinic acid, about 6 mL of a tetra methyl ammonium chloride solution and about 0.5 g of polyvinylpyrrolidone (PVP); and the nanoparticle coolant additive has a pH of about 8.

In one embodiment, a nanofluid, in accordance with the principles of the present disclosure, comprises: a base fluid comprising about 1 L of distilled water; a mixed carbon solvent comprising between about 0.1 g and about 0.3 g of single-walled carbon nanotubes; a buffering agent comprising NaOH; and a surfactant comprising between about 0.1 g and about 1.0 g of polyvinylpyrrolidone (PVP).

In one embodiment, a nanofluid, in accordance with the principles of the present disclosure, comprises: a base fluid comprising about 1 L of distilled water; a mixed carbon solvent comprising about 0.15 g of single-walled carbon nanotubes; a buffering agent comprising NaOH; and a surfactant comprising about 0.5 g of polyvinylpyrrolidone (PVP).

In one embodiment, in accordance with the principles of the present disclosure, a method of producing a nanoparticle coolant additive comprises: adding mixed carbon additives with an inorganic acid to form a mixed carbon solvent; adding a mixed metal salt precursor to the mixed carbon solvent to form a first combination; adding a peptizing agent and an organic acid to the first combination to form a second combination; adding a buffering agent to the second combination to form a third combination having a pH between about 8.0 and about 14.0; sonicating the third combination with heating to form a fourth combination; and adding mixed organic surfactants to the fourth combination to form the nanoparticle coolant additive.

In some embodiments, the third combination is sonicated between about 0.1 hours and about 6 hours with heating between to between about 20° C. and about 180° C. to form the fourth combination.

In some embodiments, between about 0.025 mL and about 6 mL of the peptizing agent and the organic acid are added to the first combination to form the second combination; and between about 0.0025 g and about 5.0 g of the mixed organic surfactants are to the fourth combination to form the nanoparticle coolant additive.

In some embodiments, the mixed carbon additives are selected from the group consisting of carbon dots, single-walled carbon nanotubes, multi-walled carbon nanotubes and combinations thereof; the inorganic acid is selected from the group consisting of phosphoric acid, sulphuric acid, hydrochloric acid, boric acid and combinations thereof; the mixed metal salt precursor is selected from the group consisting of iron (III) chloride hexahydrate (FeCl₃·6H₂O), cupric (II) chloride dihydrate (CuCl₂·2H₂O), silver nitrate (AgNO₃), Cobalt (II) nitrate hexahydrate (Co(NO₃)₂·6H₂O), Nickel (II) chloride hexahydrate (NiCl₂·6H₂O), Manganese (II) chloride, Zinc sulfate heptahydrate (ZnSO₄·7H₂O) and combinations thereof; the peptizing agent is selected from the group consisting of Cetyltrimethylammonium bromide (CTAB), Ammonium hydroxide (NH₄OH), Tetra-n-butylammonium bromide (TBAB), 2-imidazole, Sodium citrate (Na₃C₆H₅O₇), Polyvinylpyrrolidone (PVP), Potassium oleate, Triethanolamine (TEA) and combinations thereof; the organic acid is selected from the group consisting of Acetic acid (CH₃COOH), Oxalic acid (C₂H₂O₄), Citric acid (C₆H₈O₇), Lactic acid (C₃H₆O₃), Salicylic acid (C₇H₆O₃), tannic acid, Gallic Acid (C₇H₆O₅) and combinations thereof; the nanoparticle coolant additive has a pH of about 8.0; and the buffering agent comprises NaOH.

In one embodiment, in accordance with the principles of the present disclosure, a method of producing a nanoparticle coolant additive comprises: treating carbon additives with an inorganic acid under sonication to form a mixed carbon solvent; washing and sonicating the mixed carbon solvent to form a solution; adding a mixed metal salt precursor, a peptizing agent and an organic acid to the solution to form a first combination; adding a buffering agent to the first combination to form a second combination having a pH between about 8.0 and about 14.0; sonicating the second combination with heating to form a third combination; washing and suspending the third combination in distilled water to form a fourth combination; and adding mixed organic surfactants to the fourth combination to form the nanoparticle coolant additive.

In some embodiments, the mixed carbon solvent is sonicated under sonication of about 15 W to about 200 W with reflux at between about 20° C. and about 120° C. for between about 0.5 hours and about 10 hours to form the solution.

In some embodiments, the method further comprises washing and sonicating the solution for between about 10 minutes and about 200 minutes.

In some embodiments, the third combination is sonicated between about 0.1 hours and about 6 hours with heating between to between about 20° C. and about 180° C. to form the fourth combination.

In some embodiments, between about 0.01 g and about 4.0 g of the carbon additives are treated with the inorganic acid to form the mixed carbon solvent; the metal salt precursor includes a first metal salt precursor and a second metal salt precursor, the wherein between about 2.0 mmol and about 6.0 mmol of the first metal salt precursor are added to the solution to form the first combination and between about 1.0 mmol and about 3.0 mmol of the second metal salt precursor is added to the solution to form the first combination; and the mixed organic surfactants includes a first organic surfactant and a second organic surfactant, the first organic surfactant comprising between about 5 wt % and about 30 wt % of the nanoparticle coolant additive and the second organic surfactant comprising between about 5 wt % and about 20 wt % of the nanoparticle coolant additive.

In some embodiments, the carbon additives are selected from the group consisting of carbon dots, single-walled carbon nanotubes, multi-walled carbon nanotubes and combinations thereof; the inorganic acid is selected from the group consisting of phosphoric acid, sulphuric acid, hydrochloric acid, boric acid and combinations thereof; the mixed metal salt precursors are each selected from the group consisting of iron (III) chloride hexahydrate (FeCl₃·6H₂O), cupric (II) chloride dihydrate (CuCl₂·2H₂O), silver nitrate (AgNO₃), Cobalt (II) nitrate hexahydrate (Co(NO₃)₂·6H₂O), Nickel (II) chloride hexahydrate (NiCl₂·6H₂O), Manganese (II) chloride, Zinc sulfate heptahydrate (ZnSO₄·7H₂O) and combinations thereof; the peptizing agent is selected from the group consisting of Cetyltrimethylammonium bromide (CTAB), Ammonium hydroxide (NH₄OH), Tetra-n-butylammonium bromide (TBAB), 2-imidazole, Sodium citrate (Na₃C₆H₅O₇), Polyvinylpyrrolidone (PVP), Potassium oleate, Triethanolamine (TEA) and combinations thereof; the organic acid is selected from the group consisting of Acetic acid (CH₃COOH), Oxalic acid (C₂H₂O₄), Citric acid (C₆H₈O₇), Lactic acid (C₃H₆O₃), Salicylic acid (C₇H₆O₃), tannic acid, Gallic Acid (C₇H₆O₅) and combinations thereof; the nanoparticle coolant additive has a pH of about 8.0; and the buffering agent comprises NaOH.

In one embodiment, in accordance with the principles of the present disclosure, a method of producing a nanoparticle coolant additive comprises: treating single-walled carbon nanotubes with sulfuric acid under sonication to form a mixture; washing and sonicating the mixture to form a solution; adding cupric chloride dihydrate, a oxalic acid and 2-imidazole to the solution to form a first combination; cooling and washing the first combination; suspending the first combination in distilled water to form a second combination; adding Polyvinylpyrrolidone (PVP) and Sodium Dodecyl Benzene Sulfonate (SDBS) to the second combination to form a third combination; and adding a buffering agent to the third combination to form the nanoparticle coolant additive.

In some embodiments, between about 0.1 g and about 0.3 g of the single-walled carbon nanotubes are treated with between about 5 mL and about 20 mL of the sulfuric acid; between about 0.25 g and about 1.0 g of the cupric chloride dihydrate, between about 0.3 g and about 1.2 g of the oxalic acid and between about 1.0 g and about 3.0 g of the 2-imidazole are added to the solution to form the first combination; and between about 0.01 g and about 0.3 g of the PVP and between about 0.01 g and about 0.2 g of the SDBS are added to the second combination to form the third combination.

In some embodiments, the mixture is washed and sonicated for about 0.5 hours to about 2 hours.

In one embodiment, in accordance with the principles of the present disclosure, a method of producing a nanoparticle coolant additive comprises: treating single-walled carbon nanotubes with sulfuric acid and nitric acid under sonication to form a mixture; centrifuging the mixture to form a first combination; adding Polyvinylpyrrolidone (PVP) to the first combination and sonicating to form a second combination; and adding a buffering agent to the second combination to form the nanoparticle coolant additive.

In some embodiments, between about 0.2 g and about 0.6 g of the single-walled carbon nanotubes are treated with between about 5 mL and about 25 mL of the sulfuric acid and between about 2.0 mL and about 8 mL of the nitric acid; and between about 0.2 g and about 0.8 g of the PVP are added to the first combination to form the second combination.

In some embodiments, the single-walled carbon nanotubes are treated with sulfuric acid and nitric acid under sonication for between about 60 minutes and about 120 minutes to form the mixture.

In some embodiments, the first combination is sonicated for between about 60 minutes and about 120 minutes to form the second combination.

In one embodiment, in accordance with the principles of the present disclosure, a method of producing a nanoparticle coolant additive comprises: treating single-walled carbon nanotubes with nitric acid under sonication to form a mixture; washing the mixture to form a first combination; adding cupric chloride dihydrate, zinc nitrate hexahydrate, succinic acid and a tetra methylammonium chloride solution to the first combination to form a second combination; stirring and sonicating the second combination to form a third combination; cooling and washing the third combination to form a fourth combination; suspending the fourth combination in distilled water and adding Polyvinylpyrrolidone (PVP) under sonication to form a fifth combination; and adding a buffering agent to the fifth combination to form the nanoparticle coolant additive.

In some embodiments, between about 0.2 g and about 0.6 g of the single-walled carbon nanotubes are treated with between about 5 mL and about 25 mL of the nitric acid under sonication for between about 50 to about 100 minutes; between about 0.1 g and about 0.4 g of the cupric chloride dihydrate, between about 0.01 g and about 0.4 g of the zinc nitrate hexahydrate, between about 5 mmol and about 20 mmol of the succinic acid and between about 3 mL and about 10 mL of the tetra methylammonium chloride solution are added to the first combination to form the second combination; and between about 0.25 g and about 1.0 g of the PVP are added under sonication to the fourth combination and the distilled water to form the fifth combination.

In one embodiment, in accordance with the principles of the present disclosure, a method of producing a nanoparticle coolant additive comprises: treating single-walled carbon nanotubes with sulfuric acid and nitric acid under heat and sonication to form a first mixture; centrifuging the first mixture to form a second mixture having a pH between about 5.5 and about 7.5; adding Polyvinylpyrrolidone (PVP) to the second mixture under sonication to form a first combination; sonicating the first combination to from a second combination; and adding a buffering agent to the second combination to form the nanoparticle coolant additive.

In some embodiments, between about 0.05 g and about 0.3 g of the single-walled carbon nanotubes are treated with between about 5 mL and about 25 mL of the nitric acid and between about 2 mL and about 10 mL of the nitric acid under heat and sonication for between about between about 1 hour and 5 hours; between about 0.25 g and about 1.0 g of the PVP are added under sonication to the second mixture to form the first combination; and the first combination is sonicated for between about 15 minutes and about 45 minutes to form the second combination.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific compositions, formulations, methods, conditions or parameters described and/or shown herein, and that the terminology used herein is for the purpose of describing particular embodiments by way of example only and is not intended to be limiting of the claimed disclosure. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Further, when such a range is expressed, it is understood that the present disclosure includes each and every integer within that range. For example, when a range of 1-10 is expressed, the range includes 1, 2, 3, 4, 5, 6, 7, 8, 9 and 10. Similarly, when values are expressed as approximations, by use of the antecedent “about,” it will be understood that the particular value forms another embodiment. For example, instances of “about 1” include “1”, instances of “about 2” include “2”, etc. The ranges disclosed herein can include any of the upper limits of the ranges in combination with any of the lower limits of the ranges. For example, instances of “about 1 to about 10” include “1” and “10”.

The following discussion includes a description of a nanoparticle coolant additives for direct-to-chip cooling, nanofluids made from such nanoparticle coolant additives and methods of producing the nanoparticle coolant additives and the nanofluids, in accordance with the principles of the present disclosure. Alternate embodiments are also disclosed. Reference will now be made in detail to the exemplary embodiments of the present disclosure.

The present disclosure relates to compositions, formulations, processes and applications for a nanoparticle coolant additive for direct-to-chip cooling. In some embodiments, a solid phase of the nanoparticle coolant additive is dispersed in a liquid of the nanoparticle coolant additive. The solid phase is made of clusters that have a dimension such to avoid phonon scattering that might occur at the liquid solid interphase. The nanoparticle coolant additive of the present disclosure is formulated and processed, taking the above into account, to maximize the heat transfer capability of the nanoparticle coolant additive. In some embodiments, the nanoparticle coolant additive can be installed into a thermal system (e.g., a direct-to-chip cooling system) with a retrofit solution, which feeds the existing heat transfer fluid into the thermal system.

A nanofluid is a heterogeneous suspension or mixture comprising two phases, a solid phase and a liquid phase, in which the dimensions of the solid phase components in suspension are nanometric. The two phases of the suspension are also separable through mechanical methods, since the substances used to form the heterogeneous mixture or suspension do not modify their structure, as is the case, for example, in the solutions.

The presence of mixed carbon additives gives the nanoparticle coolant additive relevant thermal, and fluid dynamic properties compared to the base fluid. For example, the thermal conductivity, heat capacity, viscosity, density and electrical conductivity.

In many nanofluids known as the state of the art, the nanoparticles of the solid phase have a tendency to deposit due to gravity. This is a phenomenon that has several consequences because it causes a reduction of the volumetric concentration of the nanoparticles inside the nanofluid therefore the thermal and fluid properties are different than expected. Furthermore, in an unstable nanofluid the particles tend to accumulate inside the pipes where the nanofluid is installed leading to clogging thus creating an obvious problem for certain applications.

Another phenomenon observed in the nanofluids known as the state of the art is the tendency of the nanopowders to generate clusters or agglomerations (solids composed by the combination of various nanometric particles) which have substantially larger dimensions of the individual particles. This phenomenon is negative, as it modifies the properties of the nanofluid, increases the tendency to settle and significantly increases the abrasion of the fluid which can lead to failures in certain components of the system.

The nanoparticle coolant additive or nanofluid of the present disclosure has a greater heat exchange capacity because it has a high thermal conductivity, a higher density and thermal capacity and provides a stable nanoparticle coolant additive, in which the solid phase does not tend to separate from the liquid phase or deposit on the pipe surface inside the system.

A particle dispersed in a liquid generally presents at the surface the electrostatic charges that generate an electric field responsible for the redistribution of the ions present around the surface of the nanoparticles. This leads to an increase in the concentration of ions with electrical charge opposite to those on the particle surface.

This electrical charge distribution causes a variable electrical potential with the distance from the particle, called zeta potential. When two particles are so close together that their double layers overlap, they repel each other with an electrostatic force whose intensity depends on the potential zeta, and at the same time attract each other for the well-known attraction of Van der Walls. If the zeta potential is too low, the repulsive force is not strong enough to overcome the Van der Walls attraction between the particles, and the particles will start to agglomerate making the suspension unstable.

In some embodiments, the nanofluid of the present disclosure is an engineered suspension of a nanoparticle coolant additive in a base fluid, the nanoparticle coolant additive including small solid metal particles (nanoparticles). Suspending small solid particles in the energy transmission fluids can improve their thermal conductivity and provides an effective and innovative way to significantly enhance their heat transfer characteristics by increasing convective heat transfer in closed loop hydronic systems, reducing energy demand. The nanoparticle coolant additive and/or nanofluid of the present disclosure can be applied to various industrial and commercial HVAC systems and related components including chillers, heat exchangers, boilers and energy recovery units. Heat exchangers are sized for certain approach temperatures. The lower the approach operational temperature, the larger the heat exchanger. In fact, the specific surface of heat exchangers depends on the temperature difference between the two thermal fluids. The surface area of heat exchangers that is needed for exchanging an amount of heat in time depends also on the fluids involved and on the material properties of the exchanger surface that is subject to degradation over time. Because the nanoparticle coolant additive and/or the nanofluid of the present disclosure leads the system fluid to higher thermal conductivity and mass flow rate, it increases heat transfer between the air and the thermal fluid, thereby increasing heat exchanger performance.

### Example 1—Producing a First Nanoparticle Coolant Additive

In some embodiments, a nanoparticle coolant additive of the present disclosure, such as, for example a first nanoparticle coolant additive is configured for use in a homogeneous and long-term stable nanofluid and is prepared by: adding mixed carbon additives with an inorganic acid to form a mixed carbon solvent; adding a mixed metal salt precursor to the mixed carbon solvent to form a first combination; adding a peptizing agent and an organic acid to the first combination to form a second combination; adding a buffering agent to the second combination to form a third combination having a pH between about 8.0 and about 14.0; sonicating the third combination with heating to form a fourth combination; and adding mixed organic surfactants to the fourth combination to form the first nanoparticle coolant additive.

In some embodiments, the mixed carbon solvent is a black solution.

In some embodiments, the third combination is sonicated between about 0.1 hours and about 12 hours with heating to between about 20° C. and about 180° C. to form the fourth combination. In some embodiments, the third combination is sonicated between about 0.15 hours and about 9 hours with heating to between about 30° C. and about 120° C. to form the fourth combination. In some embodiments, the third combination is sonicated between about 0.2 hours and about 6 hours with heating to between about 40° C. and about 90° C. to form the fourth combination.

In some embodiments, between about 0.025 mL and about 6 mL of the peptizing agent and/or the organic acid is added to the first combination to form the second combination. In some embodiments, between about 0.03 mL and about 5 mL of the peptizing agent and/or the organic acid are added to the first combination to form the second combination. In some embodiments, between about 0.04 mL and about 4 mL of the peptizing agent and/or the organic acid are added to the first combination to form the second combination. In some embodiments, between about 0.05 mL and about 3 mL of the peptizing agent and/or the organic acid are added to the first combination to form the second combination. In some embodiments, between about 0.05 mL and about 3 mL of the peptizing agent and between about 0.05 mL and about 3 mL of the organic acid are added to the first combination to form the second combination. In some embodiments, between about 0.05 mL and about 3 mL of the peptizing agent and the organic acid combined are added to the first combination to form the second combination.

In some embodiments, between about 0.0025 g and about 5.0 g of the mixed organic surfactants are to the fourth combination to form the first nanoparticle coolant additive. In some embodiments, between about 0.003 g and about 4.0 g of the mixed organic surfactants are to the fourth combination to form the first nanoparticle coolant additive. In some embodiments, between about 0.004 g and about 3.0 g of the mixed organic surfactants are to the fourth combination to form the first nanoparticle coolant additive. In some embodiments, between about 0.005 g and about 2.5 g of the mixed organic surfactants are to the fourth combination to form the first nanoparticle coolant additive.

In some embodiments, the mixed carbon additives are selected from the group consisting of carbon dots, single-walled carbon nanotubes, multi-walled carbon nanotubes, reduced graphene oxide, graphene nanoplatelets, carbon black, amorphous carbon composites, carbon fiber additives, fullerene carbon nanotubes, pyrolytic graphite, nitrogen-doped carbon materials, hybrid aerogels and combinations thereof. In some embodiments, the mixed carbon additives are single-walled carbon nanotubes.

In some embodiments, the inorganic acid is selected from the group consisting of phosphoric acid, sulphuric acid, hydrochloric acid, boric acid and combinations thereof. In some embodiments, the inorganic acid is sulphuric acid.

In some embodiments, the mixed metal salt precursor is selected from the group consisting of iron (III) chloride hexahydrate (FeCl₃·6H₂O), cupric (II) chloride dihydrate (CuCl₂·2H₂O), silver nitrate (AgNO₃), Cobalt (II) nitrate hexahydrate (Co(NO₃)₂·6H₂O), Nickel (II) chloride hexahydrate (NiCl₂·6H₂O), Manganese (II) chloride, Zinc sulfate heptahydrate (ZnSO₄·7H₂O), metal salts, such as, for example, Bimetallic or trimetallic nitrates (e.g., zinc nitrate and copper nitrate; aluminum nitrate and magnesium nitrate), mixed chlorides (e.g., calcium chloride and nickel chloride; iron chloride and cobalt chloride), multimetallic sulfates (e.g., copper sulfate and magnesium sulfate; zinc sulfate and manganese sulfate), oxalates (like iron oxalate, magnesium oxalates, etc), hydroxides like aluminium hydroxide, nickel hydroxide, zinc hydroxide, magnesium hydroxide and combinations thereof. In some embodiments, the mixed metal salt precursor is cupric (II) chloride dihydrate (CuCl₂·2H₂O).

In some embodiments, the peptizing agent is selected from the group consisting of Cetyltrimethylammonium bromide (CTAB), Ammonium hydroxide (NH₄OH), Tetra-n-butylammonium bromide (TBAB), 2-imidazole, Sodium citrate (Na₃C₆H₅O₇), Polyvinylpyrrolidone (PVP), Potassium oleate, Triethanolamine (TEA) and combinations thereof. In some embodiments, the peptizing agent is Polyvinylpyrrolidone (PVP). In some embodiments, the peptizing agent is 2-imidazole.

In some embodiments, the organic acid is selected from the group consisting of Acetic acid (CH₃COOH), Oxalic acid (C₂H₂O₄), Citric acid (C₆H₈O₇), Lactic acid (C₃H₆O₃), Salicylic acid (C₇H₆O₃), tannic acid, Gallic Acid (C₇H₆O₅) and combinations thereof. In some embodiments, the organic acid is Oxalic acid (C₂H₂O₄).

In some embodiments, the mixed organic surfactants are selected from the group consisting of Sodium Dodecyl Benzene Sulfonate (SDBS), Cetyltrimethylammonium Bromide (CTAB), Benzalkonium Chloride, Triton X-100, PVP K-15, PVP K-17, PVP K-25, PVP K-30, PVP 58000, PVP K-90, Carboxymethyl Cellulose (CMC) and combinations thereof. In some embodiments, the mixed organic surfactants include at least two of Sodium Dodecyl Benzene Sulfonate (SDBS), Cetyltrimethylammonium Bromide (CTAB), Benzalkonium Chloride, Triton X-100, PVP K-15, PVP K-17, PVP K-25, PVP K-30, PVP 58000, PVP K-90, Carboxymethyl Cellulose (CMC). In some embodiments, the mixed organic surfactants include Sodium Dodecyl Benzene Sulfonate (SDBS) and Polyvinylpyrrolidone (PVP).

In some embodiments, the buffering agent is selected from the group consisting of NaOH, sodium phosphate, ammonium phosphate, potassium phosphate, potassium carbonate, sodium carbonate, sodium bicarbonate, sodium borate, potassium borate, boric acid with sodium hydroxide, ammonium hydroxide, ammonium chloride, ammonium carbonate and combinations thereof. In some embodiments, the buffering agent is NaOH.

In some embodiments, the first nanoparticle coolant additive has a pH of about 8.0. In some embodiments, the first nanoparticle coolant additive has a pH of about 9.0. In some embodiments, the first nanoparticle coolant additive has a pH of about 10.0. In some embodiments, the first nanoparticle coolant additive has a pH of about 11.0. In some embodiments, the first nanoparticle coolant additive has a pH of about 12.0. In some embodiments, the first nanoparticle coolant additive has a pH of about 13.0. In some embodiments, the first nanoparticle coolant additive has a pH of about 14.0. In some embodiments, the first nanoparticle coolant additive has a pH less than about 15.0. In some embodiments, the first nanoparticle coolant additive has a pH less than about 14.0. In some embodiments, the first nanoparticle coolant additive has a pH less than about 13.0. In some embodiments, the first nanoparticle coolant additive has a pH less than about 12.0. In some embodiments, the first nanoparticle coolant additive has a pH less than about 11.0. In some embodiments, the first nanoparticle coolant additive has a pH less than about 10.0. In some embodiments, the first nanoparticle coolant additive has a pH less than about 9.0. In some embodiments, the first nanoparticle coolant additive has a pH less than about 8.0. In some embodiments, the first nanoparticle coolant additive has a pH less than about 7.0. In some embodiments, the first nanoparticle coolant additive has a pH greater than about 7.0. In some embodiments, the first nanoparticle coolant additive has a pH greater than about 8.0. In some embodiments, the first nanoparticle coolant additive has a pH greater than about 9.0. In some embodiments, the first nanoparticle coolant additive has a pH greater than about 10.0. In some embodiments, the first nanoparticle coolant additive has a pH greater than about 11.0. In some embodiments, the first nanoparticle coolant additive has a pH greater than about 12.0. In some embodiments, the first nanoparticle coolant additive has a pH greater than about 13.0. In some embodiments, the first nanoparticle coolant additive has a pH greater than about 14.0.

In one particular embodiment, the first nanoparticle coolant additive is formed by (1) adding mixed carbon additives with an inorganic acid (mixture/s) to a solvent to form a black solution, (2) adding mixed metal salt precursor, (3) adding 0.05 to 3 ml of peptizing agent and organic acid, (4) maintaining pH 8-14 with sodium hydroxide, (5) sonicating the mixture for 0.2 to 6 hours along with heating to 40-90° C., and (6) adding 0.005 g to 2.5 g of mixed organic surfactants. As would be appreciated by one of ordinary skill in the art, sonication helps to achieve a uniform dispersion in the solution by breaking the agglomerated carbon materials. Sonication enhances the effective surface area of the carbon additives, improving their interaction with other components (e.g., the inorganic acids and the metal salts). Sonication also promotes efficient mixing of the metal salt precursors, acids, and peptizing agents, ensuring uniform reaction conditions. Furthermore, sonication accelerates reaction kinetics by increasing the energy and mobility of reactants. Sonication provides energy through acoustic cavitation which is the rapid formation and collapse of bubbles to facilitate nucleation and growth of nanoparticles from the metal salt precursors. It allows uniformity to the nanoparticle size and morphology due to controlled environment created by sonication. Lastly, organic acid functionalizes the carbon additives/nanoparticle formula and sonication helps in achieving uniform modification by exposing reactive sites.

In some embodiments, the first nanoparticle coolant additive is added to a base fluid to form a first nanofluid. In some embodiments, the base fluid is selected from the group consisting of tap water, distilled water, heat transfer fluids, dielectric fluid, NOVEC™, FLUORINERT™, propylene glycol (PG), ethylene glycol (EG), water-glycol mixtures (glycol: PG, EG) and combinations thereof. In some embodiments, the base fluid is water. In some embodiments, the base fluid comprises between about 80% and about 99.9% by weight or volume. In some embodiments, the nanoparticle coolant additive range is between about 0.01% and about 20% by weight or volume.

### Example 2—Producing a Second Nanoparticle Coolant Additive

In some embodiments, a nanoparticle coolant additive of the present disclosure, such as, for example a second nanoparticle coolant additive is configured for use in a homogeneous and long-term stable nanofluid and is prepared by: treating carbon additives with an inorganic acid under sonication to form a mixed carbon solvent; washing and sonicating the mixed carbon solvent to form a solution; adding a mixed metal salt precursor, a peptizing agent and an organic acid to the solution to form a first combination; adding a buffering agent to the first combination to form a second combination having a pH between about 8.0 and about 14.0; sonicating the second combination with heating to form a third combination; washing and suspending the third combination in distilled water to form a fourth combination; and adding mixed organic surfactants to the fourth combination to form the second nanoparticle coolant additive.

In some embodiments, the carbon additives are treated with an inorganic acid under sonication to form the mixed carbon solvent, wherein the inorganic acid is selected from the group consisting of Phosphoric acid, Sulphuric acid, nitric acid, hydrochloric acid, Boric acid and combinations thereof. In some embodiments, the inorganic acid is Sulphuric acid.

In some embodiments, the process of treating and washing the carbon/nanoparticle coolant additive involves removing impurities, ensuring uniformity, and preparing the additives for their cooling application. In some embodiments, the washing is done using centrifugation. The treated mixture is placed in a centrifuge and spun at high speed (e.g., 9000 rpm) to separate the solid component (carbon additives) from the acidic solution and reaction by-products. For centrifugation washing each cycle is run for approximately 3 minutes. After centrifugation, the surfactant is decanted, leaving the carbon additives in the centrifuge tube. The solid residue is resuspended in water and mixed to dilute any remaining acid or impurities. The suspension is centrifuged again, and the process is repeated 3-5 times until the pH of the supernatant is neutral (pH 6-7), indicating the removal of acidic residues. As would be appreciated by one of ordinary skill in the art, washing eliminates acid residuals, and amorphous carbon from the raw carbon additives. The washing reduces contamination that could affect their thermal, electrical, and rheological properties.

In some embodiments, the mixed carbon solvent is sonicated under sonication of about 15 W to about 200 W with reflux at between about 20° C. and about 120° C. for between about 0.5 hours and about 10 hours to form the solution. In some embodiments, the mixed carbon solvent is sonicated under sonication of about 20 W to about 175 W with reflux at between about 25° C. and about 110° C. for between about 0.75 hours and about 8 hours to form the solution. In some embodiments, the mixed carbon solvent is sonicated under sonication of about 25 W to about 150 W with reflux at between about 30° C. and about 100° C. for between about 0.8 hours and about 7.5 hours to form the solution. In some embodiments, the mixed carbon solvent is sonicated under sonication of about 30 W to about 130 W with reflux at between about 40° C. and about 90° C. for between about 1 hour and about 7 hours to form the solution.

In some embodiments, the method of producing the second nanoparticle coolant additive further comprises washing and sonicating the solution for between about 10 minutes and about 200 minutes. In some embodiments, the method of producing the second nanoparticle coolant additive further comprises washing and sonicating the solution for between about 15 minutes and about 150 minutes. In some embodiments, the method of producing the second nanoparticle coolant additive further comprises washing and sonicating the solution for between about 20 minutes and about 120 minutes.

In some embodiments, the solution is a black solution.

In some embodiments, the mixed metal salt precursor is selected from the group consisting of iron (III) chloride hexahydrate (FeCl₃·6H₂O), cupric (II) chloride dihydrate (CuCl₂·2H₂O), silver nitrate (AgNO₃), Cobalt(II) nitrate hexahydrate (Co(NO₃)₂·6H₂O), Nickel(II) chloride hexahydrate (NiCl₂·6H₂O), Manganese (II) chloride, Zinc sulfate heptahydrate (ZnSO₄·7H₂O), metal salts (e.g., Bimetallic or trimetallic nitrates (e.g., zinc nitrate and copper nitrate)), aluminum nitrate and magnesium nitrate, mixed chlorides (e.g., calcium chloride and nickel chloride; iron chloride and cobalt chloride, multimetallic sulfates (e.g., copper sulfate and magnesium sulfate; zinc sulfate and manganese sulfate, oxalates (e.g., iron oxalate, magnesium oxalates, etc), hydroxides (e.g., aluminium hydroxide, nickel hydroxide, zinc hydroxide, magnesium hydroxide) and combinations thereof. In some embodiments, the mixed metal salt precursor includes at least two of iron (III) chloride hexahydrate (FeCl₃·6H₂O), cupric (II) chloride dihydrate (CuCl₂·2H₂O), silver nitrate (AgNO₃), Cobalt(II) nitrate hexahydrate (Co(NO₃)₂·6H₂O), Nickel(II) chloride hexahydrate (NiCl₂·6H₂O), Manganese (II) chloride and Zinc sulfate heptahydrate (ZnSO₄·7H₂O), metal salts (e.g., Bimetallic or trimetallic nitrates (e.g., zinc nitrate and copper nitrate)), aluminum nitrate and magnesium nitrate, mixed chlorides (e.g., calcium chloride and nickel chloride, iron chloride and cobalt chloride, multimetallic sulfates (e.g., copper sulfate and magnesium sulfate, zinc sulfate and manganese sulfate, oxalates (e.g., iron oxalate, magnesium oxalates, etc), hydroxides (e.g., aluminum hydroxide, nickel hydroxide, zinc hydroxide and magnesium hydroxide).

In some embodiments, the peptizing agent is selected from the group consisting of Cetyltrimethylammonium bromide (CTAB), Ammonium hydroxide (NH₄OH), Tetra-n-butylammonium bromide (TBAB), 2-imidazole, Sodium citrate (Na₃C₆H₅O₇), Polyvinylpyrrolidone (PVP), Potassium oleate, Triethanolamine (TEA) and combinations thereof. In some embodiments, the peptizing agent is Polyvinylpyrrolidone (PVP). In some embodiments, the peptizing agent is 2-imidazole.

In some embodiments, the organic acid is selected from the group consisting of Acetic acid (CH₃COOH), Oxalic acid (C₂H₂O₄), Citric acid (C₆H₈O₇), Lactic acid (C₃H₆O₃), Salicylic acid (C₇H₆O₃), tannic acid, Gallic Acid (C₇H₆O₅) and combinations thereof. In some embodiments, the organic acid is Oxalic acid (C₂H₂O₄).

In some embodiments, the buffering agent is sodium hydroxide.

In some embodiments, the second combination is sonicated with heating to between about 40° C. and about 110° C. for between about 0.01 hours and about 10 hours form the third combination. In some embodiments, the second combination is sonicated with heating to between about 50° C. and about 100° C. for between about 0.05 hours and about 10 hours form the third combination. In some embodiments, the second combination is sonicated with heating to between about 60° C. and about 80° C. for between about 0.1 hours and about 8 hours form the third combination. In some embodiments, the second combination is sonicated with heating to at about 70° C. for between about 0.2 hours and about 6 hours form the third combination.

In some embodiments, the mixed organic surfactants are selected from the group consisting of Sodium Dodecyl Benzene Sulfonate (SDBS), Cetyltrimethylammonium Bromide (CTAB), Benzalkonium Chloride, Triton X-100, PVP K-15, PVP K-17, PVP K-25, PVP K-30, PVP 58000, PVP K-90, Carboxymethyl Cellulose (CMC) and combinations thereof. In some embodiments, the mixed organic surfactants include at least two of Sodium Dodecyl Benzene Sulfonate (SDBS), Cetyltrimethylammonium Bromide (CTAB), Benzalkonium Chloride, Triton X-100, PVP K-15, PVP K-17, PVP K-25, PVP K-30, PVP 58000, PVP K-90, Carboxymethyl Cellulose (CMC). In some embodiments, the mixed organic surfactants include Sodium Dodecyl Benzene Sulfonate (SDBS) and Polyvinylpyrrolidone (PVP).

In some embodiments, the second nanoparticle coolant additive includes between about 0.01 g and about 4.0 g of the carbon additives are treated with the inorganic acid to form the mixed carbon solvent; the metal salt precursor includes a first metal salt precursor and a second metal salt precursor, the wherein between about 2.0 mmol and about 6.0 mmol of the first metal salt precursor is added to the solution to form the first combination and between about 1.0 mmol and about 3.0 mmol of the second metal salt precursor is added to the solution to form the first combination; and the mixed organic surfactants includes a first organic surfactant and a second organic surfactant, the first organic surfactant comprising between about 5 wt % and about 30 wt % of the second nanoparticle coolant additive and the second organic surfactant comprising between about 5 wt % and about 20 wt % of the second nanoparticle coolant additive.

In some embodiments, the carbon additives are selected from the group consisting of carbon dots, single-walled carbon nanotubes, multi-walled carbon nanotubes and combinations thereof; the inorganic acid is selected from the group consisting of phosphoric acid, sulphuric acid, hydrochloric acid, boric acid and combinations thereof; the mixed metal salt precursors are each selected from the group consisting of iron (III) chloride hexahydrate (FeCl₃·6H₂O), cupric (II) chloride dihydrate (CuCl₂·2H₂O), silver nitrate (AgNO₃), Cobalt (II) nitrate hexahydrate (Co(NO₃)₂·6H₂O), Nickel (II) chloride hexahydrate (NiCl₂·6H₂O), Manganese (II) chloride, Zinc sulfate heptahydrate (ZnSO₄·7H₂O) and combinations thereof; the peptizing agent is selected from the group consisting of Cetyltrimethylammonium bromide (CTAB), Ammonium hydroxide (NH₄OH), Tetra-n-butylammonium bromide (TBAB), 2-imidazole, Sodium citrate (Na₃C₆H₅O₇), Polyvinylpyrrolidone (PVP), Potassium oleate, Triethanolamine (TEA) and combinations thereof; the organic acid is selected from the group consisting of Acetic acid (CH₃COOH), Oxalic acid (C₂H₂O₄), Citric acid (C₆H₈O₇), Lactic acid (C₃H₆O₃), Salicylic acid (C₇H₆O₃), tannic acid, Gallic Acid (C₇H₆O₅) and combinations thereof; the nanoparticle coolant additive has a pH of about 8.0; and the buffering agent comprises 0.1 M NaOH.

In some embodiments, the second nanoparticle coolant additive is prepared in two step-synthesis. Firstly, 0.1-2 g of carbon additive(s) (CA) is treated with inorganic acid(s) under mild sonication of 30 -130 W with reflux at 40-90° C. for 1-7 hours. This mixture is washed and sonicated again for 20 -120 minutes to form a black solution. To this 4.2 mmol of a metal first salt precursor and 2 mmol of a metal second salt precursor is added followed by 0.5-2.5 ml of 10-30% peptizing agent and 10 mmol of organic acid. The pH is maintained between 8-14 before thermal treatment. The reaction mixture is sonicated for 0.2 to 6 hours while maintaining the temperature to 70° C. The mixture is washed and suspended in distilled water using probe sonication in the presence of 15 wt % of a first organic surfactant and 10 wt % of a second organic surfactant. The pH of the second nanoparticle coolant additive obtained is maintained ~8 using 0.1M sodium hydroxide (NaOH). The obtained second nanoparticle coolant additive is homogeneous and provides long-term stability, low viscosity and zero sedimentation in a nanofluid.

In some embodiments, the second nanoparticle coolant additive is added to a base fluid to form a second nanofluid. In some embodiments, the base fluid is selected from the group consisting of tap water, distilled water, heat transfer fluids, dielectric fluid, NOVEC™, FLUORINERT™, propylene glycol (PG), ethylene glycol (EG), water-glycol mixtures (glycol: PG, EG) and combinations thereof. In some embodiments, the base fluid is water. In some embodiments, the base fluid comprises between about 80% and about 99.9% by weight or volume of the nanofluid. In some embodiments, the nanoparticle coolant additive comprises between about 0.01% and about 20% by weight or volume of the nanofluid.

### Example 3—Producing a Third Nanoparticle Coolant Additive

In some embodiments, a nanoparticle coolant additive of the present disclosure, such as, for example a third nanoparticle coolant additive is configured for use in a homogeneous and long-term stable nanofluid and is prepared by: treating single-walled carbon nanotubes with sulfuric acid under sonication to form a mixture; washing and sonicating the mixture to form a solution; adding cupric chloride dihydrate, a oxalic acid and 2-imidazole to the solution to form a first combination; cooling and washing the first combination; suspending the first combination in distilled water to form a second combination; adding Polyvinylpyrrolidone (PVP) and Sodium Dodecyl Benzene Sulfonate (SDBS) to the second combination to form a third combination; adding a buffering agent to the third combination to form the third nanoparticle coolant additive. In some embodiments, the third nanoparticle coolant additive is added to a base fluid to form a third nanofluid. In some embodiments, the base fluid comprises between about 80% and about 99.9% by weight or volume of the nanofluid. In some embodiments, the nanoparticle coolant additive comprises between about 0.01% and about 20% by weight or volume of the nanofluid.

In some embodiments, between about 0.1 g and about 0.3 g of the single-walled carbon nanotubes are treated with between about 5 mL and about 20 mL of the sulfuric acid. In some embodiments, between about 0.15 g and about 0.25 g of the single-walled carbon nanotubes are treated with between about 8 mL and about 15 mL of the sulfuric acid. In some embodiments, about 0.2 g of the single-walled carbon nanotubes are treated with about 10 mL of the sulfuric acid.

In some embodiments, between about 0.25 g and about 1.0 g of the cupric chloride dihydrate, between about 0.3 g and about 1.2 g of the oxalic acid and between about 1.0 g and about 3.0 g of the 2-imidazole are added to the solution to form the first combination. In some embodiments, between about 0.35 g and about 0.8 g of the cupric chloride dihydrate, between about 0.4 g and about 1.0 g of the oxalic acid and between about 1.5 g and about 2.5 g of the 2-imidazole are added to the solution to form the first combination. In some embodiments, about 0.5 g of the cupric chloride dihydrate, about 0.6 g of the oxalic acid and about 2.0 g of the 2-imidazole are added to the solution to form the first combination.

In some embodiments, between about 0.01 g and about 0.3 g of the PVP and between about 0.01 g and about 0.2 g of the SDBS are added to the second combination to form the third combination. In some embodiments, between about 0.05 g and about 0.25 g of the PVP and between about 0.05 g and about 0.175 g of the SDBS are added to the second combination to form the third combination. In some embodiments, between about 0.1 g and about 0.125 g of the PVP and between about 0.07 g and about 0.15 g of the SDBS are added to the second combination to form the third combination. In some embodiments, about 0.15 g of the PVP and about 0.1 g of the SDBS are added to the second combination to form the third combination.

In one particular embodiment, the third nanoparticle coolant additive is prepared by: treating 0.2 g of single walled carbon nanotubes with 10 ml of sulfuric acid under sonication for 1 hour. The mixture is washed and sonicated for another 30 minutes. To this 0.5 g of cupric chloride dihydrate, 0.6 g oxalic acid and 2 g of 2-imidazole is added under stirring. This mixture is sonicated for 60 minutes at 45 W while maintaining the temperature at 70° C. The reaction mixture is allowed to cool. Washed. The solution mixture is suspended in distilled water and addition of 0.15 g PVP and 0.1 g SDBS using probe sonication for 20 minutes. The pH is ~8 maintained using NaOH.

### Example 4—Producing a Fourth Nanoparticle Coolant Additive

In some embodiments, a nanoparticle coolant additive of the present disclosure, such as, for example a fourth nanoparticle coolant additive is configured for use in a homogeneous and long-term stable nanofluid and is prepared by: treating single-walled carbon nanotubes with sulfuric acid and nitric acid under sonication to form a mixture; centrifuging the mixture to form a first combination; adding Polyvinylpyrrolidone (PVP) to the first combination and sonicating to form a second combination; adding a buffering agent to the second combination to form the fourth nanoparticle coolant additive.

In some embodiments, the fourth nanoparticle coolant additive is added to a base fluid to form a fourth nanofluid. In some embodiments, the base fluid comprises between about 80% and about 99.9% by weight or volume of the nanofluid. In some embodiments, the nanoparticle coolant additive comprises between about 0.01% and about 20% by weight or volume of the nanofluid.

It is noted that, at least in some embodiments, the sulfuric acid and the nitric acid used to treat the single-walled carbon nanotubes will not be present in the fourth nanoparticle coolant additive. That is, due to sigma and pi bonds that are formed between carbon and oxygen atoms, which create a hydrogen bonding situation. This is in contrast to methods that include use of a protecting group, for example, to prevent bonding between the sulfuric acid and the nitric acid with the single-walled carbon nanotubes. Due to the bonding between the sulfuric acid and the nitric acid with the single-walled carbon nanotubes, at least in some embodiments, the fourth nanoparticle coolant additive will include only the single-walled carbon nanotubes and the PVP. For example, in one embodiment, the fourth nanoparticle coolant additive consists of about 0.15 g of the single-walled carbon nanotubes and about 0.4 g of the PVP.

In some embodiments, between about 0.2 g and about 0.6 g of the single-walled carbon nanotubes are treated with between about 5 mL and about 25 mL of the sulfuric acid and between about 2.0 mL and about 8 mL of the nitric acid. In some embodiments, between about 0.3 g and about 0.5 g of the single-walled carbon nanotubes are treated with between about 10 mL and about 20 mL of the sulfuric acid and between about 3.0 mL and about 7 mL of the nitric acid. In some embodiments, about 0.4 g of the single-walled carbon nanotubes are treated with about 15 mL of the sulfuric acid and about 5 mL of the nitric acid.

In some embodiments, between about 0.2 g and about 0.8 g of the PVP is added to the first combination to form the second combination. In some embodiments, between about 0.3 g and about 0.5 g of the PVP is added to the first combination to form the second combination. In some embodiments, about 0.4 g of the PVP is added to the first combination to form the second combination.

In some embodiments, the single-walled carbon nanotubes are treated with sulfuric acid and nitric acid under sonication for between about 40 minutes and about 120 minutes to form the mixture. In some embodiments, the single-walled carbon nanotubes are treated with sulfuric acid and nitric acid under sonication for between about 50 minutes and about 90 minutes to form the mixture. In some embodiments, the single-walled carbon nanotubes are treated with sulfuric acid and nitric acid under sonication for between about 60 minutes and about 80 minutes to form the mixture. In some embodiments, the single-walled carbon nanotubes are treated with sulfuric acid and nitric acid under sonication for about 70 minutes to form the mixture.

In some embodiments, the first combination is sonicated for between about 60 minutes and about 120 minutes to form the second combination. In some embodiments, the first combination is sonicated for between about 70 minutes and about 100 minutes to form the second combination. In some embodiments, the first combination is sonicated for about 90 minutes to form the second combination.

In one particular embodiment, the fourth nanoparticle coolant additive is prepared by: treating 0.4 g of single-walled carbon nanotubes with 15 ml of sulfuric acid and 5 ml of nitric acid under sonication for 70 minutes. The mixture is centrifuged. To this, add 0.4 g of PVP and sonicate for another 90 minutes. The pH is ~8 maintained using NaOH.

### Example 5—Producing a Fifth Nanoparticle Coolant Additive

In some embodiments, a nanoparticle coolant additive of the present disclosure, such as, for example a fifth nanoparticle coolant additive is configured for use in a homogeneous state and long-term stable nanofluid and is prepared by: treating single-walled carbon nanotubes with nitric acid under sonication to form a mixture; washing the mixture to form a first combination; adding cupric chloride dihydrate, zinc nitrate hexahydrate, succinic acid and a tetra methylammonium chloride solution to the first combination to form a second combination; stirring and sonicating the second combination to form a third combination; cooling and washing the third combination to form a fourth combination; suspending the fourth combination in distilled water and adding Polyvinylpyrrolidone (PVP) under sonication to form a fifth combination; and adding a buffering agent to the fifth combination to form the fifth nanoparticle coolant additive. In some embodiments, the fifth nanoparticle coolant additive is added to a base fluid to form a fifth nanofluid. In some embodiments, the base fluid comprises between about 80% and about 99.9% by weight or volume of the nanofluid. In some embodiments, the nanoparticle coolant additive comprises between about 0.01% and about 20% by weight or volume of the nanofluid.

In some embodiments, between about 0.2 g and about 0.6 g of the single-walled carbon nanotubes are treated with between about 5 mL and about 25 mL of the nitric acid under sonication for between about 50 to about 120 minutes. In some embodiments, between about 0.25 g and about 0.4 g of the single-walled carbon nanotubes are treated with between about 7 mL and about 15 mL of the nitric acid under sonication for between about 60 to about 110 minutes. In some embodiments, about 0.3 g of the single-walled carbon nanotubes are treated with about 10 mL of the nitric acid under sonication for about 100 minutes.

In some embodiments, between about 0.1 g and about 0.4 g of the cupric chloride dihydrate, between about 0.01 g and about 0.4 g of the zinc nitrate hexahydrate, between about 5 mmol and about 20 mmol of the succinic acid and between about 3 mL and about 10 mL of the tetra methylammonium chloride solution are added to the first combination to form the second combination. In some embodiments, between about 0.15 g and about 0.3 g of the cupric chloride dihydrate, between about 0.1 g and about 0.25 g of the zinc nitrate hexahydrate, between about 8 mmol and about 12 mmol of the succinic acid and between about 4 mL and about 8 mL of the tetra methylammonium chloride solution are added to the first combination to form the second combination. In some embodiments, about 0.23 g of the cupric chloride dihydrate, about 0.16 g of the zinc nitrate hexahydrate, about 10 mmol of the succinic acid and about 6 mL of the tetra methylammonium chloride solution are added to the first combination to form the second combination.

In some embodiments, between about 0.2 g and about 1.0 g of the PVP is added under sonication to the fourth combination and the distilled water to form the fifth combination. In some embodiments, between about 0.3 g and about 0.5 g of the PVP is added under sonication to the fourth combination and the distilled water to form the fifth combination. In some embodiments, about 0.4 g of the PVP is added under sonication to the fourth combination and the distilled water to form the fifth combination.

In one particular embodiment, the fifth nanoparticle coolant additive is prepared by: treating 0.3 g of single-walled carbon nanotubes with 10 ml of nitric acid under sonication for 100 minutes. The mixture is washed. To this 0.23 g of cupric chloride dihydrate, 0.16 g of zinc nitrate hexahydrate, 10 mmol of succinic acid and 6 ml of tetra methyl ammonium chloride solution is added under stirring. This mixture magnetically stirred for 30 minutes followed by sonication for 80 minutes at 70 W. The reaction mixture is allowed to cool. Washed. The solution mixture is suspended in distilled water and addition of 0.5 g PVP using probe sonication for 20 minutes. The pH is ~8 maintained using NaOH.

### Example 6—Producing a Sixth Nanoparticle Coolant Additive

In some embodiments, a nanoparticle coolant additive of the present disclosure, such as, for example, a sixth nanoparticle coolant additive is configured for use in a homogeneous and long-term stable nanofluid and is prepared by: treating 0.15 g of single-walled carbon nanotubes with 15 ml of sulfuric acid and 5 ml of nitric acid under heat and sonication for 3 hours. The mixture is centrifuged until the pH is 6.5. To this, add 0.4 g of PVP and sonicate for another 60 minutes, 55 W. Rest for 30 minutes and sonicate again for 20 minutes, 90 W. The pH is ~8 maintained using NaOH. The sixth nanoparticle coolant additive that results from this method includes 0.15 g of the single-walled carbon nanotubes and 0.4 g of the PVP and has a pH of about 8.0.

In some embodiments, the sixth nanoparticle coolant additive is added to a base fluid to form a sixth nanofluid. In some embodiments, the base fluid comprises between about 80% and about 99.9% by weight or volume of the nanofluid. In some embodiments, the nanoparticle coolant additive comprises between about 0.01% and about 20% by weight or volume of the nanofluid.

As noted above, the sulfuric acid and the nitric acid used to treat the single-walled carbon nanotubes will not be present in the sixth nanoparticle coolant additive. That is, due to sigma and pi bonds that are formed between carbon and oxygen atoms, which create a hydrogen bonding situation. Due to the bonding between the sulfuric acid and the nitric acid with the single-walled carbon nanotubes, the sixth nanoparticle coolant additive will include only the single-walled carbon nanotubes and the PVP. For example, in one embodiment, the sixth nanoparticle coolant additive consists of about 0.15 g of the single-walled carbon nanotubes and about 0.4 g of the PVP.

The nanoparticle coolant additives and nanofluids of the present disclosure have a wide scope of uses including HVAC, power generation, chemical processing and data center cooling. With respect to HVAC, one or more the nanoparticle coolant additives and/or nanofluids disclosed herein can be applied to various industrial and commercial HVAC systems and related components including chillers, heat exchangers, boilers and energy recovery units. In any hydronic heating and/or cooling system, the nanoparticle coolant additives and/or nanofluids lower heat exchanger approach temperatures, increasing heat transfer efficiency and reducing energy loss.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A nanofluid, comprising:
a base fluid;
a mixed carbon solvent;
a mixed metal salt precursor;
a peptizing agent;
an organic acid;
a buffering agent; and
a surfactant.

2. The nanofluid recited in claim 1, wherein the base fluid is selected from the group consisting of tap water, distilled water, heat transfer fluids, dielectric fluid, NOVEC™, FLUOROINERT™, propylene glycol, ethylene glycol, water-glycol mixtures and combinations thereof.

3. The nanofluid recited in claim 1, wherein the base fluid is distilled water.

4. The nanofluid recited in claim 1, wherein the mixed carbon solvent comprises mixed carbon additives and an inorganic acid.

5. The nanofluid recited in claim 4, wherein the mixed carbon additives are selected from the group consisting of carbon dots, single-walled carbon nanotubes, multi-walled carbon nanotubes and combinations thereof.

6. The nanofluid recited in claim 4, wherein the mixed carbon additives are single-walled carbon nanotubes.

7. The nanofluid recited in claim 4, wherein the inorganic acid is selected from the group consisting of phosphoric acid, sulphuric acid, hydrochloric acid, boric acid and combinations thereof.

8. The nanofluid recited in claim 1, wherein:
the mixed metal salt precursor comprises a first mixed metal salt precursor and a second mixed metal salt precursor; and
the first mixed metal salt precursor is different than the second mixed metal salt precursor.

9. The nanofluid recited in claim 8, wherein:
the first mixed metal salt precursor is selected from the group consisting of iron (III) chloride hexahydrate (FeCl₃·6H₂O), cupric (II) chloride dihydrate (CuCl₂·2H₂O), silver nitrate (AgNO₃), Cobalt (II) nitrate hexahydrate (Co(NO₃)₂·6H₂O), Nickel (II) chloride hexahydrate (NiCl₂·6H₂O), Manganese (II) chloride, Zinc sulfate heptahydrate (ZnSO₄·7H₂O), combinations thereof; and
the second mixed metal salt precursor is selected from the group consisting of FeCl₃·6H₂O, CuCl₂·2H₂O, AgNO₃, Co(NO₃)₂·6H₂O, NiCl₂·6H₂O, Manganese (II) chloride, ZnSO₄·7H₂O and combinations thereof.

10. The nanofluid recited in claim 1, wherein the peptizing agent is selected from the group consisting of Cetyltrimethylammonium bromide (CTAB), Ammonium hydroxide (NH₄OH), Tetra-n-butylammonium bromide (TBAB), 2-imidazole, Sodium citrate (Na₃C₆H₅O₇), Polyvinylpyrrolidone (PVP), Potassium oleate, Triethanolamine (TEA) and combinations thereof.

11. The nanofluid recited in claim 1, wherein the organic acid is selected from the group consisting of Acetic acid (CH₃COOH), Oxalic acid (C₂H₂O₄), Citric acid (C₆H₈O₇), Lactic acid (C₃H₆O₃), Salicylic acid (C₇H₆O₃), tannic acid, Gallic Acid (C₇H₆O₅) and combinations thereof.

12. The nanofluid recited in claim 1, wherein the surfactant comprises mixed organic surfactants.

13. The nanofluid recited in claim 1, wherein:
the surfactant comprises a first surfactant and a second surfactant; and
the first surfactant is different than the second surfactant.

14. The nanofluid recited in claim 13, wherein:
the first surfactant is selected from the group consisting of Sodium Dodecyl Benzene Sulfonate (SDBS), Cetyltrimethylammonium Bromide (CTAB), Benzalkonium Chloride, Triton X-100, PVP K-15, PVP K-17, PVP K-25, PVP K-30, PVP 58000, PVP K-90, Carboxymethyl Cellulose (CMC) and combinations thereof; and
the second surfactant is selected from the group consisting of SDBS, CTAB, Benzalkonium Chloride, Triton X-100, PVP K-15, PVP K-17, PVP K-25, PVP K-30, PVP 58000, PVP K-90, CMC and combinations thereof.

15. The nanofluid recited in claim 1, wherein the buffering agent comprises NaOH.

16. The nanofluid recited in claim 1, wherein the nanoparticle coolant additive has a pH between about 8.0 and about 14.0.

17. The nanofluid recited in claim 1, wherein the nanoparticle coolant additive has a pH of about 8.0.

18. The nanofluid recited in claim 1, wherein the nanoparticle coolant additive comprises:
about 0.01 mL to about 6.0 mL of the peptizing agent and the organic acid; and
about 0.001 g to about 5.0 g of the surfactant.

19. The nanofluid recited in claim 1, wherein the nanoparticle coolant additive comprises:
about 0.05 mL to about 3.0 mL of the peptizing agent and the organic acid; and
about 0.005 g to about 2.5 g of the surfactant.

20. The nanofluid recited in claim 1, wherein:
the mixed carbon solvent comprises between about 0.01 g and about 4.0 g of mixed carbon additives that are treated with inorganic acids;
the mixed metal salt precursor comprises between about 1.0 mmol and about 8.0 mmol of a first mixed metal salt precursor and between about 1.0 mmol and about 4.0 mmol of a second mixed metal salt precursor;
the surfactant comprises between about 5 wt % and about 15 wt % of a first surfactant and between about 5.0 wt % and about 10 wt % of a second surfactant; and
the nanoparticle coolant additive comprises:
between about 0.1 mL and about 5.0 mL of the peptizing agent,
between about 5 mmol and about 20 mmol of the organic acid, and
between about 0.01 M and about 0.2 M of the buffering agent.
